(19) United States
(12) Patent Application Publication
(10) Pub. No.: US 2021/0253467 A1
(43) Pub. Date: Aug. 19, 2021

(54) METHOD OF SHAPING GLASS SHEETS

(71) Applicant: PILKINGTON GROUP LIMITED, LATHOM (GB)

(72) Inventors: JOHN STEPHAN TOMIK, LASALLE, MI (US); ROBERT J. BOISSELLE, MAUMEE, OH (US); KATHRYN LEWIS, PERRYSBURG, OH (US)

(73) Assignee: PILKINGTON GROUP LIMITED, LATHOM (GB)

(21) Appl. No.: 17/055,638

(22) PCT Filed: May 16, 2019
(86) PCT No.: PCT/GB2019/051351

§ 371 Date: Nov. 16, 2020

Related U.S. Application Data
(60) Provisional application No. 62/672,781, filed on May 17, 2018.

(51) Int. Cl. C03B 23/03

(52) U.S. Cl. CPC C03B 23/03; C03B 2215/61; C03B 2225/02

(57) ABSTRACT

A method of shaping glass sheets is provided. A first glass sheet is shaped after it has been deposited on a first bending tool at a first position and an edge portion of the first sheet contacted to move the first sheet to a second position relative to the first bending tool, and a second glass sheet is also shaped after it has been deposited on the first bending tool at a first position and an edge portion of the second sheet contacted to move the second sheet to a second position relative to the first bending tool. The second position of the first edge portion of the first sheet is different than the second position of the first edge portion of the second glass sheet relative to the first bending tool. The first and second glass sheets may be of different sizes, and may be laminated together after each is shaped.

### BACKGROUND

The invention relates to shaping glass sheets, especially using opposing bending tools. The invention also relates to a method of shaping glass sheets and a bending tool utilized therein that improves shaping.

Various processes are known for shaping or bending a sheet of glass. Typically, a glass sheet is heated to a temperature where the glass sheet is deformable and then the bending process is carried out. In certain bending processes, the heated glass sheet is supported on a ring member and allowed to sag under the influence of gravity, with or without the assistance of an additional pressing force. Following bending, the glass sheet should possess a desired shape, be dimensionally stable, and not be optically distorted. Otherwise, the bending process results in waste or products that possess poor quality.

Typically, laminated glass products that are curved comprise two glass sheets and each of the glass sheets is of a different size. Known bending process utilize shaping members that are configured to bend glass sheets of the same size. Such processes are not suitable for consecutively bending glass sheets which are of substantially different sizes. For example, known bending processes are not suitable for consecutively bending a first glass sheet that is to be utilized as the inner pane of glass in a laminated windshield and a second glass sheet that is to be utilized as the outer pane of glass in the laminated windshield.

Thus, it would be advantageous to develop a method of shaping a glass sheet and a bending tool that at least partially overcomes the aforementioned limitations of the known designs.

Accordingly the present invention provides a method of shaping glass sheets comprising: providing a first glass sheet; heating the first glass sheet to a temperature suitable for shaping; depositing the first glass sheet on a first bending tool, a first edge portion of the first glass sheet being in a first position relative to the first bending tool; contacting the first edge portion of the first glass sheet after the first glass sheet has been deposited on the first bending tool such that the first edge portion of the first glass sheet is moved to a second position relative to the first bending tool; shaping the first glass sheet on the first bending tool; providing a second glass sheet; heating the second glass sheet to a temperature suitable for shaping; depositing the second glass sheet on the first bending tool, a first edge portion of the second glass sheet being in a first position relative to the first bending tool; contacting the first edge portion of the second glass sheet after the second glass sheet has been deposited on the first bending tool such that the first edge portion of the second glass sheet is moved to a second position relative to the first bending tool, wherein the second position of the first edge portion of the first glass sheet relative to the first bending tool is different than the second position of the first edge portion of the second glass sheet relative to the first bending tool; and shaping the second glass sheet on the first bending tool.

Preferably the first glass sheet and the second glass sheet are of different sizes.

Preferably one or more edge portions of the first glass sheet have a length which is different than a length of a corresponding edge portion of the second glass sheet.

Preferably the first glass sheet and the second glass sheet each comprise a leading edge portion and a trailing edge portion, with a first pillar edge portion and a second pillar edge portion extending therebetween, each of the first pillar edge portions having a length, and wherein the length of the first pillar edge portion of the first glass sheet is different from the length of the first pillar edge portion of the second glass sheet.

Preferably the first bending tool comprises a female, ring-type mold.

Preferably the first glass sheet and the second glass sheet are shaped consecutively, such that no glass sheet is shaped on the first bending tool between the shaping of the first glass sheet and the shaping of the second glass sheet.

Preferably the method further comprises laminating the first glass sheet to the second glass sheet.

In some embodiments the first glass sheet and the second glass sheet each comprise a leading edge portion and a trailing edge portion, wherein the first edge portion of the first glass sheet defines the trailing edge of the first glass sheet, and the first edge portion of the second glass sheet defines the trailing edge of the second glass sheet.

Preferably the trailing edge of the first glass sheet and the trailing edge of the second glass sheet each have a length, the length of the trailing edge of the first glass sheet being different from the length of the trailing edge of the second glass sheet.

In some embodiments the first bending tool cooperates with a second bending tool to shape the first glass sheet and the second glass sheet.

Preferably the second bending tool comprises a full-face male mold.

### BRIEF DESCRIPTION OF THE SEVERAL VIEWS OF THE DRAWING

The above, as well as other advantages of the present invention will become readily apparent to those skilled in the art from the following detailed description when considered in the light of the accompanying drawings in which:

FIG. 1 is a schematic representation of an embodiment of a glass shaping line in accordance with the invention;

FIG. 2 is a top view of an embodiment of a portion of the glass shaping line of FIG. 1;

FIG. 3 is a top view of another embodiment of the portion of the glass shaping line of FIG. 1;

FIG. 4 is a top view of an embodiment of a portion of the glass shaping line of FIG. 1 with certain portions removed for clarity;

FIG. 5 is a side view of an embodiment of a portion of a first bending tool suitable for use in the glass shaping line of FIG. 1;

FIG. 6 is a sectional view through a portion of a positioning apparatus of the first bending tool of FIG. 4 for use in the glass shaping line of FIG. 1; and

FIG. 7 is a perspective view of an embodiment of a portion of a first bending tool suitable for use in the glass shaping line of FIG. 1.

### DETAILED DESCRIPTION

It is to be understood that the invention may assume various alternative orientations and step sequences, except where expressly specified to the contrary. It is also to be understood that the specific methods, devices, apparatuses, and features illustrated in the attached drawings, and described in the following specification are simply exemplary embodiments of the inventive concepts. Hence, specific dimensions, directions, or other physical characteristics relating to the embodiments disclosed are not to be considered as limiting, unless expressly stated otherwise. Also, although they may not be, like elements found in the aforementioned embodiments may be referred to with like identifiers within this section of the application.

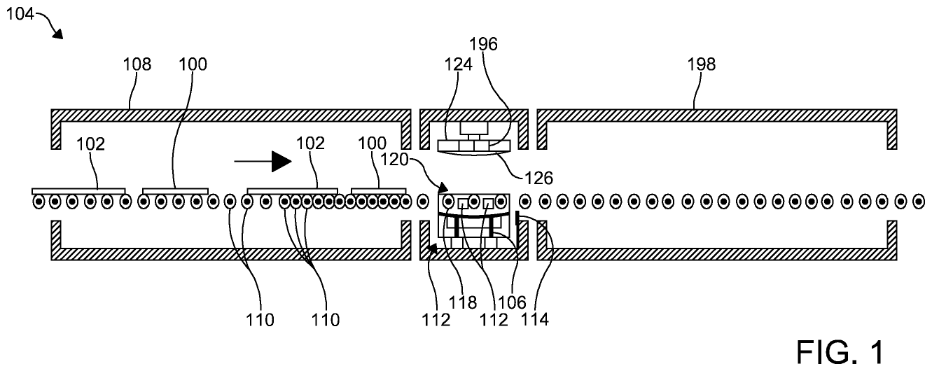

Embodiments of a method of shaping glass sheets, a glass shaping line, and a bending tool utilized therein are described herein and with reference to FIGS. 1-7. These embodiments may be described below with reference to a first glass sheet 100 and a second glass sheet 102. The first glass sheet 100 and the second glass sheet 102 may be configured in a similar manner.

The first glass sheet 100 and the second glass sheet 102 may be utilized as separate portions of a window such as, for example, a windshield for an automobile. However, each glass sheet 100, 102 may be used apart from the other and/or have other automotive applications. For example, the first glass sheet 100 and/or the second glass sheet 102 may be utilized to form a side window, sunroof, or a rear window. Such a window may be monolithic or laminated. Additionally, each glass sheet 100, 102 may have other vehicle applications such as, for example, applications to on-highway and off-highway vehicles. Also, each glass sheet 100, 102 may have architectural, electronic, industrial, locomotive, naval, aerospace, and other applications.

In certain embodiments, each glass sheet 100, 102 has a soda-lime-silicate composition. A typical soda-lime-silicate glass composition is (by weight), SiO₂ 69-74%; Al₂O₃ 0-3%; Na₂O 10-16%; K₂O 0-5%; MgO 0-6%; CaO 5-14%; SO₃ 0-2% and Fe₂O₃ 0.005-2%. The glass composition may also contain other additives, for example, refining aids, which would normally be present in an amount of up to 2%. In other embodiments, the first glass sheet 100 and/or the second glass sheet 102 may be of another composition. For example, the first glass sheet 100 and/or the second glass sheet 102 may be of a borosilicate composition or an aluminosilicate composition. Preferably, the thickness of each glass sheet 100, 102 is between 0.5-25 millimetres (mm), typically between 0.5-8 mm.

Preferably, each glass sheet 100, 102 has a first major surface and a second major surface. The second major surface opposes the first major surface. Each glass sheet 100, 102 may comprise one or more edge portions. As used herein, an edge portion of the glass sheet 100, 102 may refer to a minor surface of the glass sheet that connects the first major surface to the second major surface. Each edge portion of the glass sheet 100, 102 can be flat or curved. In an embodiment, each glass sheet 100, 102 comprises a leading edge portion and a trailing edge portion. The leading edge portion may refer to the minor surface of the glass sheet that connects the first major surface to the second major surface and is conveyed in a direction of glass travel in advance of the trailing edge portion. In an embodiment, the trailing edge portion is the longest minor surface of the glass sheet 100, 102 that connects the first major surface to the second major surface. In this embodiment, the leading edge portion is of a length which is less than the length of the trailing edge portion. In other embodiments (not depicted), the leading edge portion is the longest minor surface of the glass sheet that connects the first major surface to the second major surface and the trailing edge portion is of a length which is less than the length of the leading edge portion. Additionally, each glass sheet 100, 102 may comprise a first pillar edge portion and a second pillar edge portion. The first pillar edge portion and second pillar edge portion are disposed on opposite sides of the glass sheet 100, 102. In an embodiment, the first pillar edge portion is a minor surface of the glass sheet 100, 102 that connects the first major surface to the second major surface. In another embodiment, the second pillar edge portion is a minor surface of the glass sheet that connects the first major surface to the second major surface.

Preferably, each glass sheet 100, 102 has a rectangular outline in plan view. In certain embodiments, the first glass sheet 100 and the second glass sheet 102 are similarly sized. Advantageously, the embodiments described herein can be practiced when the first glass sheet 100 and the second glass sheet 102 are of substantially different sizes. For example, the glass shaping line 104 may be utilized to consecutively shape the first glass sheet 100 and the second glass sheet 102 when the first glass sheet 100 and the second glass sheet 102 are of substantially different sizes. This embodiment may be desirable when the first glass sheet 100 and the second glass sheet 102 are to be used as the inner pane and the outer pane of a windshield. In this embodiment, one or more edge portions of the first glass sheet 100 may be of a length which is different than a length of a corresponding edge portion of the second glass sheet 102. For example, the trailing edge portion of the first glass sheet 100 may be of a first length and the trailing edge portion of the second glass sheet 102 may be of a second length.

In this embodiment, the first length is less than the second length or vice versa. Also, in this embodiment, the leading edge portion of the first glass sheet 100 may be of a length that is less than or greater than a length of the leading edge portion of the second glass sheet 102. Further, in some embodiments, the first pillar edge portion of the first glass sheet 100 may be of a length that is less than or greater than a length of the first pillar edge portion of the second glass sheet 102. In these embodiments, the second pillar edge portion of the first glass sheet 100 may be of a length that is less than or greater than a length of the second pillar edge portion of the second glass sheet 102.

FIG. 1 illustrates an embodiment of the glass shaping line 104. In certain embodiments, the glass shaping line 104 is of the press bending variety. In other embodiments (not depicted), the glass shaping line is of the gravity bending variety. Preferably, the steps utilized to shape the first glass sheet 100 and the second glass sheet 102 are similar. Thus, for describing certain embodiments of the method of shaping the glass sheets 100, 102, the glass shaping line 104, and the bending tool 106 utilized therein only the first glass sheet 100 may be described below. It should be appreciated that the embodiments described in relation to the first glass sheet 100 may also be applicable to the second glass sheet 102.

Preferably, the glass shaping line 104 includes a preheating furnace 108. The preheating furnace 108 serves to heat each glass sheet 100, 102 before bending occurs. In the preheating furnace 108, each glass sheet 100, 102 is heated to a temperature suitable for shaping. For example, the first glass sheet 100 and the second glass sheet 102 may be heated to a temperature of 590-670° C. Accordingly, each glass sheet 100, 102 may also be referred to as a heated glass sheet.

Each glass sheet 100, 102 is transported through the furnace 108 on rollers 110. The rollers 110 are spaced apart. The spacing of the rollers 110 is reduced near the exit of the preheating furnace 108 as in this location each glass sheet 100, 102 in a heated state is deformable and therefore requires greater support.

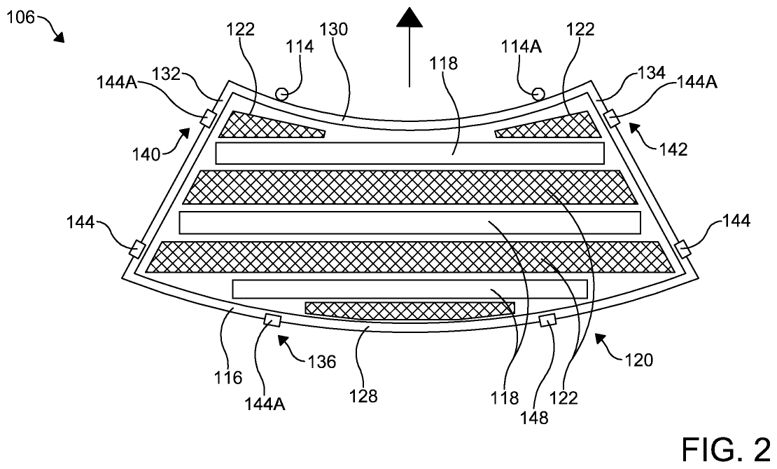

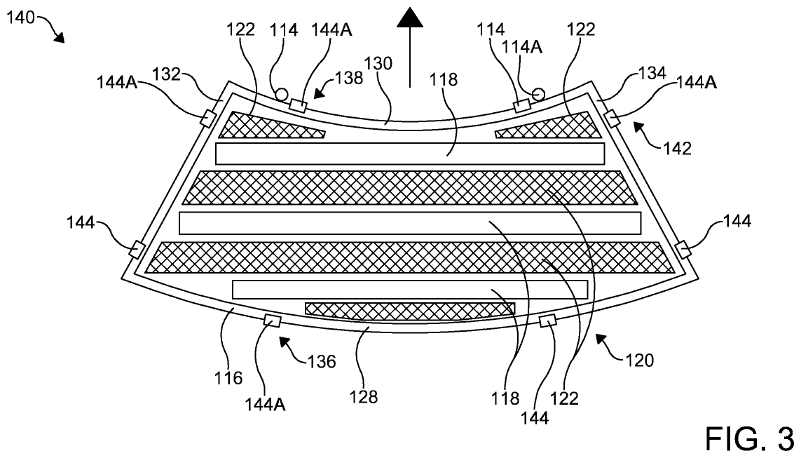

The preheating furnace 108 is followed by a bending station 112. The bending station 112 may include one or more glass stopping apparatuses 114, 114A. The one or more glass stopping apparatuses 114, 114A may be used to prevent a glass sheet 100, 102 from moving past a first bending tool 106 before it is deposited on the first bending tool 106. As shown in FIGS. 2-3, when provided, the one or more glass stopping apparatuses 114, 114A may comprise two glass stopping apparatuses 114, 114A. The one or more glass stopping apparatuses 114, 114A may be disposed about a peripheral edge of the first bending tool 106 to facilitate preventing the glass sheets 100, 102 from moving beyond a shaping surface 116 of the first bending tool 106 before the glass sheet 100, 102 has been shaped.

Referring back to FIG. 1, the bending station 112 may also comprise a plurality of rollers 118, which are provided for conveying each glass sheet 100, 102 to a location above the first bending tool 106. It is preferred that each roller of the plurality of rollers 118 rotates to convey the glass sheets 100, 102 in a direction of glass travel, which is illustrated in FIG. 1 with respect to the glass shaping line 104 and in FIGS. 2-3 with respect to a portion of the first bending tool 106. Also, it is preferred that the plurality of rollers 118 convey each glass sheet 100, 102 at a height or distance above the first bending tool 106 when the first bending tool 106 is in a rest position. It may also be preferred that the height that the plurality of rollers 118 conveys each glass sheet 100, 102 at is substantially constant.

Once a glass sheet 100, 102 exits the preheating furnace 108, the glass sheet 100, 102 is transferred from the rollers 110 in the preheating furnace 108 to the plurality of rollers 118. As illustrated in FIGS. 2-3, in certain embodiments, the plurality of rollers 118 may comprise rollers that are of different lengths. In other embodiments (not depicted), the plurality of rollers may comprise rollers of substantially equal lengths. As illustrated in FIGS. 1-3, each roller of the plurality of rollers 118 is spaced apart from an adjacent roller. The spaces provided between the rollers 118 may be equal in size. It is preferred that each roller of the plurality of rollers 118 is movable in that each roller can be moved vertically in a downward direction or in an upward direction.

In certain embodiments, the glass shaping line 104 comprises a fluid pad assembly 120. The fluid pad assembly 120 facilitates positioning each glass sheet 100, 102 on the first bending tool 106 and transferring the glass sheet 100, 102 from the plurality of rollers 118 to the first bending tool 106. The fluid pad assembly 120 comprises one or more fluid pads 122. It is preferred that a plurality of fluid pads 122 are provided. When a plurality of fluid pads 122 are provided, the fluid pads 122 may be configured as an array. The plurality of rollers 118, fluid pad assembly 120, and the fluid pads 122 may operate and be as described in PCT patent application no. PCT/GB2017/053414, the entire disclosure of which is hereby incorporated by reference.

Preferably, when the fluid pad assembly 120 is provided, the fluid pad assembly 120 is activated before the leading edge portion of a glass sheet 100, 102 reaches the one or more glass stopping apparatuses 114, 114A. In certain embodiments, the one or more the one or more glass stopping apparatuses 114, 114A may be utilized to regulate the position a glass sheet 100, 102 relative to the shaping surface 116 of the first bending tool 106. The one or more glass stopping apparatuses 114, 114A may be vertically movable in the upward direction or downward direction. After contacting a glass sheet 100,102, the one or more glass stopping apparatuses 114, 114A move away from the leading edge portion of the glass sheet 100, 102 to avoid interference with one or more of the bending tools 106, 124 when the glass sheet 100, 102 is being shaped. In an embodiment, the one or more glass stopping apparatuses 114, 114A move away from the leading edge portion of the glass sheet 100, 102 vertically in a downward direction. In another embodiment (not depicted), the one or more glass stopping apparatuses 114, 114A move away from the glass sheet 100, 102 in a direction of glass travel.

Referring back to FIG. 1, the bending station 112 includes the first bending tool 106 and, in certain embodiments, a second bending tool 124 that cooperates with the first bending tool 106 to shape the glass sheets 100, 102. It can be appreciated that the bending station 112 may comprise more bending tools 106, 124 than those shown in FIG. 1. Also, the bending tools 106, 124 shown in FIG. 1 may be oriented in a position other than the positions shown in FIG. 1.

The second bending tool 124 may be a male tool. In an embodiment, the second bending tool 124 is a full-face mold. In these embodiments, the second bending tool 124 may comprise a convex shaping surface 126. Suitable embodiments of the second bending tool 124 are described in International Publication No. WO2016/189319 A1, the entire disclosure of which is hereby incorporated by reference.

As mentioned above, each glass sheet 100, 102 has a first major surface and a second major surface. After the glass sheet 100, 102 is deposited on the first bending tool 106, the first major surface of the glass sheet 100, 102 faces the shaping surface 116 of the first bending tool 106. When a second bending tool 124 is provided, the second major surface of the glass sheet 100, 102 faces the shaping surface 126 of the second bending tool 124.

The first bending tool 106 may be a female tool. In certain embodiments, the first bending tool may be as described in PCT/GB2017/053527, the entire disclosure of which is hereby incorporated by reference. In an embodiment, the first bending tool 106 is a ring-type mold. As illustrated best in FIGS. 2-3, the first bending tool 106 may have a generally rectangular outline or periphery configured to support a glass sheet 100, 102 also having a rectangular outline. The first bending tool 106 comprises a shaping surface 116, in particular a concave shaping surface. As used herein, the shaping surface 116 of the first bending tool 106 refers to the portion of the first bending tool 106 that the glass sheet 100, 102 is deposited on and any position, configuration, or orientation thereof. More particularly, the first bending tool 106 comprises an upper shaping surface 116 for shaping and supporting the glass sheet 100, 102 thereon. After a glass sheet 100, 102 has been received by the first bending tool 106, the glass sheet 100, 102 is supported on the shaping surface 116. The shaping surface 116 may be configured to support the glass sheet 100, 102 in a peripheral region thereof. The first bending tool 106 may also support a stack of glass sheets thereon, in particular a nested pair separated by a suitable parting agent such as calcium carbonate.

The shaping surface 116 is at least partially defined by a first segment 128. In some embodiments, the shaping surface 116 is at least partially defined by a second segment 130. The first segment 128 is spaced apart from the second segment 130. In the embodiments described and illustrated, the first segment 128 will be described and depicted with reference to a segment of the first bending tool 106 which is configured to receive the trailing edge portion of a glass sheet 100, 102. However, it should be appreciated that the first segment 128 could refer to a segment of the first bending tool 106 configured to receive a pillar edge portion of the glass sheet 100, 102 or the leading edge portion of the glass sheet 100, 102. Once an edge portion of the glass sheet 100, 102 is received, the first segment 128 is configured to support the edge portion of the glass sheet 100, 102. Additionally, in certain embodiments, the second segment 130 will be described and depicted with reference to a segment of the first bending tool 106 which is configured to receive the leading edge portion of the glass sheet 100, 102. However, it should be appreciated that the second segment 130 could refer to a segment of the first bending tool 106 configured to receive a pillar edge portion of the glass sheet 100, 102 or the trailing edge portion of the glass sheet 100, 102. Once an edge portion of the glass sheet 100, 102 is received, the second segment 130 is configured to support the edge portion of the glass sheet 100, 102. In these embodiments, once the leading edge portion of the glass sheet 100, 102 is received, the second segment 130 is configured to support the leading edge portion of the glass sheet 100, 102.

Positioned at one end of the first segment 128 and the second segment 130 is a third segment 132. More particularly, a first end of the third segment 132 is spaced apart from a first end of the first segment 128 and a second end of the third segment 132 is spaced apart from a first end of the second segment 130. When provided, the third segment 132 at least partially defines the shaping surface 116 of the first bending tool 106. In certain embodiments, the third segment 132 is configured to receive a first pillar edge portion of a glass sheet 100, 102. In these embodiments, once the first pillar edge portion of the glass sheet 100, 102 is received, the third segment 132 is configured to support the first pillar edge portion of the glass sheet 100, 102.

Positioned at another end of the first segment 128 and the second segment 130 is a fourth segment 134. More particularly, a first end of the fourth segment 134 is spaced apart from a second end of the first segment 128 and a second end of the fourth segment 134 is spaced apart from a second end of the second segment 130. When provided, the fourth segment 134 at least partially defines the shaping surface 116 of the first bending tool 106. In certain embodiments, the fourth segment 134 is configured to receive a second pillar edge portion of a glass sheet 100, 102.

Preferably, when provided, the first segment 128, second segment 130, third segment 132, and fourth segment 134 each define a discrete portion of the shaping surface 116 of the first bending tool 106. When a first glass sheet 100, 102 is supported on the shaping surface 116 of the first bending tool 106, the glass sheet 100, 102 is disposed over the first segment 128, second segment 130, third segment 132, and fourth segment 134. The segments 128-134 may define the generally rectangular outline. In certain embodiments, the first segment 128, second segment 130, third segment 132, and fourth segment 134 are configured as a ring which supports a glass sheet 100, 102 in a peripheral region thereof. However, the first bending tool 106 may have other configurations. For example, in an embodiment, the first segment 128 may not be provided in a parallel relationship with the second segment 130. In other embodiments, the third segment 132 may not be provided in a parallel relationship with the fourth segment 134. In still other embodiments, the outline of the first bending tool 106 may be trapezoidal or have other forms suitably configured to support the particular glass sheet to be shaped. Also, as is illustrated in FIGS. 2-3, one or more of the segments 128-134 may comprise one or more curved portions.

In an embodiment, the first segment 128 is movable. In this embodiment, it is preferred that the first segment 128 is movable and moves in a direction which is toward the second segment 130. Also, in this embodiment, it is preferred that the first segment 128 moves in a direction which is away from the second segment 130. In certain embodiments, the direction in which the first segment 128 moves toward the second segment 130 is parallel to the direction of glass travel. Preferably, a glass sheet 100, 102 is deposited on the first bending tool 106 when the first segment 128 moves toward the second segment 130. It is also preferred that the first segment 128 is in a rest position when the glass sheet 100, 102 is shaped on the first bending tool 106. In some embodiments, the first segment 128 moves toward the second segment 130 for one second or less. In other embodiments, the first segment 128 moves toward the second segment 130 or away from the second segment 130 in a half-second or less.

In certain embodiments, the second segment 130 may be movable. When the second segment 130 is movable, it is preferred that the second segment 130 is movable and moves in a direction which is toward the first segment 128. It is also preferred that, in these embodiments, the second segment 130 is movable and moves in a direction which is away from the first segment 128. In certain embodiments, the direction in which the second segment 130 moves toward the first segment 128 is parallel to the direction of glass travel. Preferably, a glass sheet 100, 102 is deposited on the first bending tool 106 when the second segment 130 moves in a direction which is toward the first segment 128. In some embodiments, the second segment 130 moves toward the first segment 128 or away from the first segment 128 in one second or less. In other embodiments, the second segment 130 moves toward or away from the first segment 128 in a half-second or less. When the second segment 130 is movable, the movement of the first segment 128 and the movement of the second segment 130 may occur in a simultaneous manner.

Preferably, the second segment 130 is stationary. In these embodiments, the position of a glass sheet 100, 102 may change with respect to the first segment 128, the third segment 132, and/or the fourth segment 134 prior to shaping. For example, when the second segment 130 is configured to receive the leading edge portion of a glass sheet 100, 102 and the first segment 128 moves in a direction toward the second segment 130 prior to the glass sheet 100, 102 being shaped, the trailing edge portion of the glass sheet 100, 102 may move on the first segment 128 in the direction of glass travel from a first position to a second position. As another example, when the second segment 130 is configured to receive the leading edge portion of a glass sheet 100, 102 and the third segment 132 moves in a direction toward the fourth segment 134 or the fourth segment 134 moves in a direction toward the third segment 132 prior to the glass sheet 100, 102 being shaped, a pillar edge portion of the glass sheet 100, 102 may move on the third segment 132 or the fourth segment 134 in a direction perpendicular to glass travel from a first position to a second position.

In an embodiment, the third segment 132 is movable. In this embodiment, it is preferred that the third segment 132 is movable and moves in a direction which is toward the fourth segment 134. It is also preferred that the third segment 132 is movable and moves in a direction which is away from the fourth segment 134. In certain embodiments, the third segment 132 moves toward the fourth segment 134 in a direction which is perpendicular to the direction of glass travel. However, in other embodiments (not depicted), the third segment 132 moves toward the fourth segment 134 in a direction which is parallel to the direction of glass travel. The third segment 132 may also move in relation to other segments. For example, in some embodiments, the third segment 132 moves in a direction which is perpendicular to the direction in which the first segment 128 moves. In these embodiments, the third segment 132 may also move in a direction which is perpendicular to the direction in which the second segment 130 moves. Preferably, a glass sheet 100, 102 is deposited on the first bending tool 106 when the third segment 132 moves toward the fourth segment. In some embodiments, the third segment 132 moves toward the fourth segment 134 or away from the fourth segment 134 in one second or less. In other embodiments, the third segment 132 moves toward the fourth segment 134 or away from the fourth segment 134 in a half-second or less.

In certain embodiments, the fourth segment 134 is movable. In one such embodiment, it is preferred that the fourth segment 134 is movable and moves in a direction which is toward the third segment 132. It is also preferred that the fourth segment 134 is movable and moves in a direction which is away from the third segment 132. When the fourth segment 134 moves toward the third segment 132, it is preferred that the fourth segment 134 moves in a direction which is perpendicular to the direction of glass travel. In some embodiments, the fourth segment 134 moves toward the third segment 132 or away from the third segment 132 in one second or less. In other embodiments, the fourth segment 134 moves toward the third segment 132 or away from the third segment 132 in a half-second or less.

In embodiments where the fourth segment 134 moves toward the third segment 132, the movement of the third segment 132 and the movement of the fourth segment 134 may occur in a simultaneous manner. For example, in embodiments where the third segment 132 moves toward the fourth segment 134 and the fourth segment 134 moves toward the third segment 132, the movement of the third segment 132 and the movement of the fourth segment 134 may occur at the same time. In some embodiments where the movement of the third segment 132 and the movement of the fourth segment 134 occur at the same time, the third segment 132 and the fourth segment 134 may both be moving toward the glass sheet 100, 102 at the same time after a glass sheet 100, 102 has been deposited on the first bending tool 106. In other embodiments, the third segment 132 and the fourth segment 134 may both be moving away from the glass sheet 100, 102 and/or each other at the same time after a glass sheet 100, 102 has been shaped. In still another embodiment, the movement of the third segment 132 and the movement of the fourth segment 134 may occur in a simultaneous manner with the movement of the first segment 128.

Preferably, when two or more segments 128-134 move prior to shaping a glass sheet 100, 102, the segments 128-134 move toward the glass sheet 100, 102 in a predetermined order. For example, prior to shaping the glass sheet 100, 102, the first segment 128 may move toward the second segment 130 and the glass sheet 100, 102. Following movement of the first segment 128, the third segment 132 and the fourth segment 134 may move toward each other and the glass sheet 100, 102. However, in other embodiments, the first segment 128, third segment 132, and fourth segment 134 may move in another predetermined order. For example, in certain embodiments, the first segment 128, third segment 132, and fourth segment 134 may each move toward the glass sheet 100, 102 at the same time. Alternatively, in other embodiments, the third segment 132 may move toward the fourth segment 134 and the glass sheet 100, 102 before the first segment 128 moves toward the second segment 130 and the glass sheet 100, 102. In this embodiment, the third segment 132 and the fourth segment 134 may move toward each other and the glass sheet 100, 102 at the same time. It is preferred that, when two or more segments 128-134 move toward a glass sheet 100, 102 in a predetermined order prior to shaping the glass sheet 100, 102, each segment that moves will have moved in a predetermined period of time. It is preferred that the predetermined period of time begins when one or more of the two or more segments 128-134 begin to move and ends when all of the two or more segments 128-134 that move toward the glass sheet 100, 102 in the predetermined order have reached a rest position. Preferably, the predetermined period of time is two seconds or less.

As illustrated best in FIG. 2, a first positioning apparatus 136 is configured to adjust the position a glass sheet 100, 102 relative to the shaping surface 116 of the first bending tool 106 after the glass sheet 100, 102 is deposited on the first bending tool 106. The first positioning apparatus 136 is provided near the outer periphery of the first segment 128. Also, as illustrated best in FIG. 3, a second positioning apparatus 138 may be provided near the outer periphery of the second segment 130. In other embodiments, a third positioning apparatus 140 may be provided near the outer periphery of the third segment 132 and a fourth positioning apparatus 142 may be provided near the outer periphery of the fourth segment 134.

In certain embodiments, each positioning apparatus 136-142 includes one or more glass positioners 144, 144A. It is preferred that the one or more glass positioners 144, 144A are disposed adjacent a periphery of the shaping surface 116 of the first bending tool 106. Each of the one or more glass positioners 144, 144A are configured to contact an edge portion of a glass sheet 100, 102 to adjust the position of the glass sheet 100, 102 relative to the shaping surface 116 of the first bending tool 106. Preferably, the one or more glass positioners 144, 144A are each similarly configured. However, the method can be practiced utilizing glass positioners that are not similarly configured and the first bending tool 106 can be configured when one or more of the one or more glass positioners 144, 144A are not similarly configured.

As illustrated in FIG. 2, the first positioning apparatus 136 may comprise two glass positioners 144, 144A. As illustrated in FIG. 3, the second positioning apparatus 138 may also comprise two glass positioners 144, 144A. Also, in certain embodiments, the third positioning apparatus 140 and the fourth positioning apparatus 142 each comprise two glass positioners 144, 144A. To adjust the position of a glass sheet 100, 102, each glass positioner 144, 144A contacts an edge portion of the glass sheet 100, 102. Contacting an edge portion of the glass sheet 100, 102 with one or glass positioners 144, 144A adjusts the position of the glass sheet 100, 102, if necessary, to a desired position on the shaping surface 116 of the first bending tool 106.

For example, a first glass positioner 144 and a second glass positioner 144A of the first positioning apparatus 136 may contact the first edge portion of the first glass sheet 100. Contact between the first glass positioner 144 and the second glass positioner 144A of the first positioning apparatus 136 and the first edge portion of the first glass sheet 100 moves the first edge portion from a first position relative to the first bending tool 106 to a second position relative to the first bending tool 106. As another example, the first glass positioner 144 and the second glass positioner 144A of the first positioning apparatus 136 may contact the first edge portion of the second glass sheet 102. Contact between the first glass positioner 144 and the second glass positioner 144A of the first positioning apparatus 136 and the first edge portion of the second glass sheet 102 moves the first edge portion from a first position relative to the first bending tool 106 to a second position relative to the first bending tool 106. In embodiments where the first glass sheet 100 and the second glass sheet 102 are of different sizes, the second position of the first edge portion of the first glass sheet 100 relative to the first bending tool 106 is different than the second position of the first edge portion of the second glass sheet 102 relative to the first bending tool 106.

At least one of the one or more glass positioners 144, 144A is moveable. In an embodiment, at least one of the first glass positioner 144 and the second glass positioner 144A of the first positioning apparatus 136 is moveable. Preferably, each glass positioner 144, 144A is moveable. For example, each of the first glass positioner 144 and the second glass positioner 144A of the first positioning apparatus 136 may be moveable. In embodiments where at least one of the glass positioners 144, 144A of the second positioning apparatus 138 is moveable, the manner in which the first glass positioner 144 and the second glass positioner 144A of the first positioning apparatus 136 move may be similar to the manner in which the glass positioners 144, 144A of the second positioning apparatus 138 move. Similarly, in embodiments where at least one of the glass positioners 144, 144A of the third positioning apparatus 140 and the fourth positioning apparatus 142 are moveable, the manner in which the first glass positioner 144 and the second glass positioner 144A of the first positioning apparatus 136 move may be similar to the manner in which the glass positioners 144, 144A of the third positioning apparatus 140 and the fourth positioning apparatus 142 move. Thus, only the movement of the first glass positioner 144 and the second glass positioner 144A of the first positioning apparatus 136 may be described below. It should be appreciated that the description of the movement of the first glass positioner 144 and the second glass positioner 144A of the first positioning apparatus 136 may be applicable to the movement of the glass positioners 144, 144A of the other positioning apparatuses 138-142.

The movement of the first glass positioner 144 and the movement of the second glass positioner 144A of the first positioning apparatus 136 may occur in a simultaneous manner. The first glass positioner 144 and the second glass positioner 144A of the first positioning apparatus 136 may be in mechanical communication with each other to enable simultaneous movement of the first glass positioner 144 and the second glass positioner 144A. Also, it is preferred that the first glass positioner 144 and the second glass positioner 144A move in a similar manner. Thus, for describing the embodiments, only the movement of the first glass positioner 144 of the first positioning apparatus 136 may be described below. It should be appreciated that the description of the movement of the first glass positioner 144 of the first positioning apparatus 136 may be applicable to the movement of the second glass positioner 144A of the first positioning apparatus 136.

Movement of the first glass positioner 144 of the first positioning apparatus 136 may be vertical in an upward direction or a downward direction. For example, before adjusting the position the first glass sheet 100 relative to the first bending tool 106, the first glass positioner 144 of the first positioning apparatus 136 may move vertically in an upward direction. After adjusting the position the first glass sheet 100 relative to the first bending tool 106, the first glass positioner 144 of the first positioning apparatus 136 may move vertically in a downward direction to a rest position. In this embodiment, the rest position may be below the shaping surface 116 of the first bending tool 106.

The movement of the first glass positioner 144 of the first positioning apparatus 136 may also be in a direction which is toward the second segment 130. It is also preferred that the first glass positioner 144 of the first positioning apparatus 136 is movable and moves in a direction which is away from the second segment 130. For example, after the position of the first glass sheet 100 has been adjusted, the first glass positioner 144 of the first positioning apparatus 136 may move away from the second segment 130. In certain embodiments, the direction in which the first glass positioner 144 of the first positioning apparatus 136 moves toward the second segment 130 is parallel to the direction of glass travel or in the same direction as the direction of glass travel.

In embodiments where the glass positioners 144, 144A of the second positioning apparatus 138 move, the glass positioners 144, 144A of the second positioning apparatus 138 may move in a direction which is toward the first segment 128. In these embodiments, the glass positioners 144, 144A of the second positioning apparatus 138 may move opposite the direction of glass travel. Also, in these embodiments, after the position of the first glass sheet 100 has been adjusted, the glass positioners 144, 144A of the second positioning apparatus 138 may move in the direction of glass travel and away from the first segment 128.

To contact the first edge portion of the first glass sheet 100 and adjust the position of the first glass sheet 100, the first glass positioner 144 of the first positioning apparatus 136 moves toward the second segment 130 from a first position to a second position. After the position of the first glass sheet 100 has been adjusted, the first glass positioner 144 of the first positioning apparatus 136 may move from the second position to the first position or another position. For example, if the next glass sheet to be shaped is configured similar to the first glass sheet 100, the first glass positioner 144 of the first positioning apparatus 136 may move from the second position to the first position. However, if the next glass sheet to be shaped is the second glass sheet 102 described above, then the first glass positioner 144 of the first positioning apparatus 136 may move from the second position to a third position. To contact the first edge portion of the second glass sheet 102 and adjust the position of the second glass sheet 102, the first glass positioner 144 of the first positioning apparatus 136 moves toward the second segment 130 from the third position to a fourth position. After the position of the second glass sheet 102 has been adjusted, the first glass positioner 130 of the first positioning apparatus 136 may move from the fourth position to the first position, third position, or another position. For example, if the next glass sheet to be shaped is configured similar to the first glass sheet 100, the first glass positioner 144 of the first positioning apparatus 136 may move from the fourth position to the first position. In embodiments, each of the first, second, third, and fourth positions may be different from the others.

Preferably, the first glass sheet 100 is deposited on the first bending tool 106 when the first glass positioner 144 of the first positioning apparatus 136 is in the first position. It is also preferred that when the second glass sheet 102 is deposited on the first bending tool 106, the first glass positioner 144 of the first positioning apparatus 136 is in the third position. Preferably, when the first glass positioner 144 of the first positioning apparatus 136 moves toward the second segment 130, the first glass positioner 144 of the first positioning apparatus 136 moves from the first position to the second position or from the third position to the fourth position. Also, it is preferred that when the first glass positioner 144 of the first positioning apparatus 136 moves in a direction which is away from the second segment 130, the first glass positioner 144 of the first positioning apparatus 136 moves from the second position to the first position or the third position. It is also preferred that the first glass positioner 144 of the first positioning apparatus 136 is in the second position or fourth position when a glass sheet 100, 102 is shaped on the first bending tool 106. In some embodiments, the first glass positioner 144 of the first positioning apparatus 136 moves from the first position to the second position or from the third position to the fourth position in one second or less. In other embodiments, the first glass positioner 144 of the first positioning apparatus 136 moves from the first position to the second position, the second position to the third position, the third position to the fourth position, or the fourth position to the first position in a half-second or less.

The glass positioners 144, 144A of the third positioning apparatus 140 and the fourth positioning apparatus 142 may also be utilized to adjust the position the first glass sheet 100 and the second glass sheet 102. To adjust the position of the first glass sheet 100 or the second glass sheet 102, one or more glass positioners 144, 144A of the third positioning apparatus 140 contact the third edge portion of the glass sheet 100, 102. Contact between one or more glass positioners 144, 144A of the third positioning apparatus 140 and the third edge portion of the glass sheet 100, 102 moves the third edge portion of the glass sheet 100, 102 from a first position to a second position relative to the first bending tool 106. To adjust the position of the first glass sheet 100 or the second glass sheet 102, one or more glass positioners 144, 144A of the fourth positioning apparatus 142 contact the fourth edge portion of the glass sheet 100, 102. Contact between one or more glass positioners 144, 144A of the fourth positioning apparatus 142 and the fourth edge portion of the glass sheet 100, 102 moves the fourth edge portion of the glass sheet 100, 102 from a first position to a second position relative to the first bending tool 106.

Each glass positioner 144, 144A of the third positioning apparatus 140 and the fourth positioning apparatus 142 may be moveable. In embodiments where one or more of the glass positioners 144, 144A of the third positioning apparatus 140 and the fourth positioning apparatus 142 is moveable, the manner in which the one or more moveable glass positioners 144, 144A of the third positioning apparatus 140 and the fourth positioning apparatus 142 move may be similar. Also, the movement of the one or more moveable glass positioners 144, 144A of the third positioning apparatus 140 and the fourth positioning apparatus 142 may occur in a simultaneous manner. In this embodiment, the moveable glass positioners 144, 144A of the third positioning apparatus 140 and the fourth positioning apparatus 142 may be in mechanical communication with each other.

Movement of the glass positioner 144, 144A of the third positioning apparatus 140 may be vertical in an upward direction or a downward direction. For example, before adjusting the position the first glass sheet 100 relative to the first bending tool 106, a glass positioner 144, 144A of the third positioning apparatus 140 may move vertically in an upward direction. After adjusting the position the first glass sheet 100 relative to the first bending tool 106, the glass positioner 144, 144A of the third positioning apparatus 140 may move vertically in a downward direction to a rest position. In this embodiment, the rest position may be below the shaping surface 116 of the first bending tool 106. A glass positioner 144, 144A of the fourth positioning apparatus 142 may move vertically in a similar manner. To enable vertical movement of the one or more glass positioners 144, 144A of the third positioning apparatus 140 and the fourth positioning apparatus 142 may be configured like the first glass positioner 144 of the first positioning apparatus 136 described above.

The movement of the glass positioners 144, 144A of the third positioning apparatus 140 may also be in a direction which is toward the fourth segment 134. It is also preferred that when the one or more glass positioners 144, 144A of the third positioning apparatus 140 are movable that movement is also in a direction which is away from the fourth segment 134. For example, after the position of a glass sheet 100, 102 has been adjusted, the one or more glass positioners 144, 144A of the third positioning apparatus 140 may move away from the fourth segment 134. In certain embodiments, the direction in which a glass positioner 144, 144A of the third positioning apparatus 140 moves is toward the fourth segment 134 and perpendicular to the direction of glass travel.

The movement of the glass positioners 144, 144A of the fourth positioning apparatus 142 may also be in a direction which is toward the third segment 132. It is also preferred that when the one or more glass positioners 144, 144A of the fourth positioning apparatus 142 are movable that movement is also in a direction which is away from the third segment 132. For example, after the position of a glass sheet 100, 102 has been adjusted, the one or more glass positioners 144, 144A of the fourth positioning apparatus 142 may move away from the third segment 132. In certain embodiments, the direction in which a glass positioner 144, 144A of the fourth positioning apparatus 142 moves is toward the third segment 132 and perpendicular to the direction of glass travel.

In certain embodiments, each positioning apparatus 136-142 is in mechanical communication with a segment 128-134. In these embodiments, each segment 128-134 may have one or more glass positioners 144, 144A in mechanical communication therewith. For example, as illustrated in FIG. 3, the first segment 128, second segment 130, third segment 132, and fourth segment 134 may each have one or more glass positioners 144, 144A in mechanical communication therewith.

The one or more glass positioners 144, 144A in mechanical communication with a segment 128-134 that moves, such as, for example, the first segment 128, may move with the segment and, prior to contacting an edge portion of the glass sheet 100, 102, in a direction which is toward the glass sheet 100, 102. The glass positioners 144, 144A in mechanical communication with a segment 128-134 that does not move may not move in a direction which is toward the glass sheet 100, 102 prior to contacting an edge portion of the glass sheet 100, 102. For example, in an embodiment, the second segment 130 may have a fixed position. In this embodiment, the second segment 130 does not move in a direction which is toward the first segment 128 or the glass sheet 100, 102 after the glass sheet 100, 102 has been deposited on the shaping surface 116 of the first bending tool 106. Thus, in this embodiment, if the one or more glass positioners 144, 144A of the second positioning apparatus 138 are in mechanical communication with the second segment 134, then the one or more glass positioners 144, 144A of the second positioning apparatus 138 may not move in a direction which is toward a glass sheet 100, 102 prior to contacting the second edge portion of the glass sheet 100, 102.

In other embodiments, the one or more glass positioners 144, 144A may move relative to the segment 128-134. In some embodiments, the movement of a glass positioner 144, 144A may be vertical in an upward or downward direction. In other embodiments, the movement of a glass positioner 144, 144A may be in a direction which is toward or away from a glass sheet 100, 102.

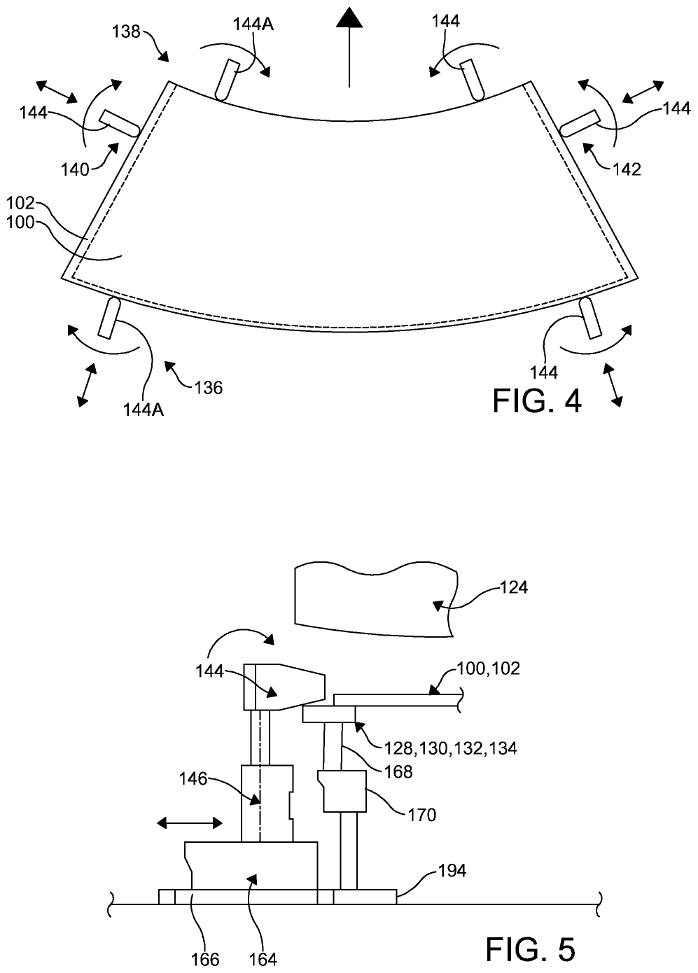

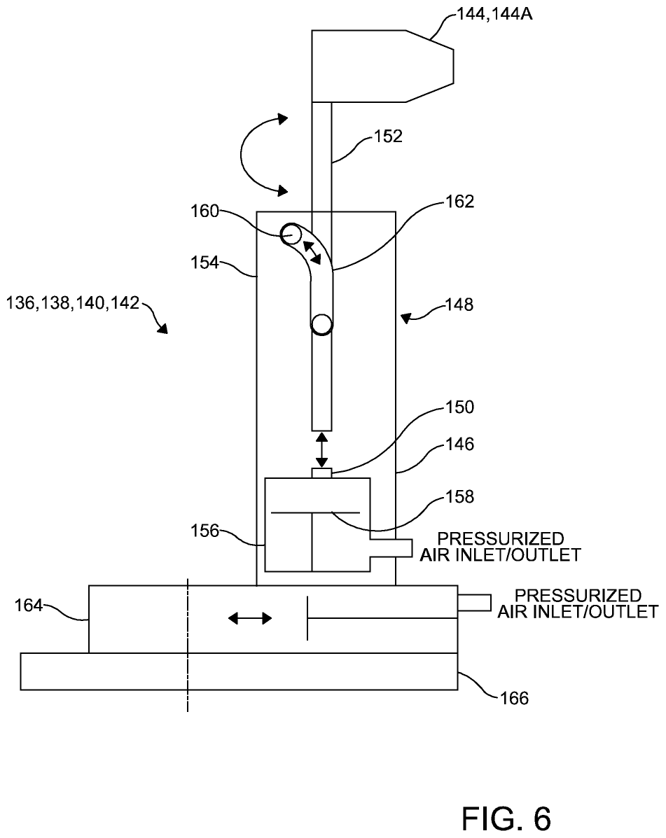

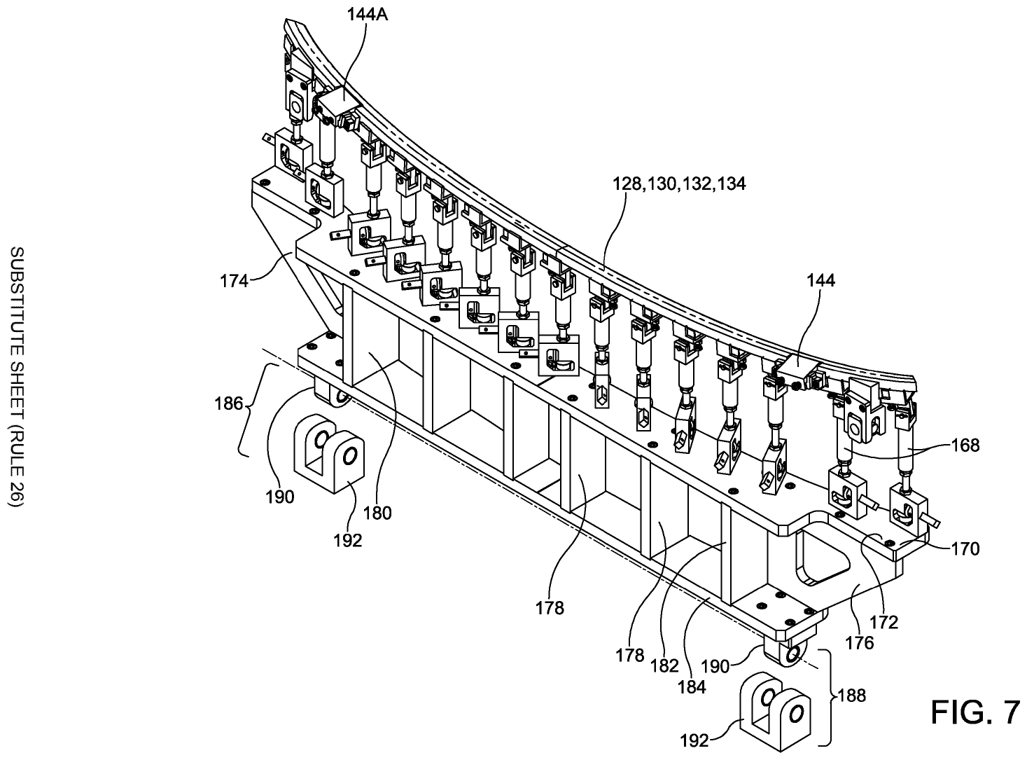

Referring now to FIGS. 5-6, in these embodiments, a positioning apparatus 136-142 may comprise a first power component 146. The first power component 146 is utilized to move the glass positioner 144, 144A vertically in an upward or downward direction. The first power component 146 may also be utilized to rotate a glass positioner 144, 144A toward a segment 128-134, which is illustrated in FIG. 4. In an embodiment, a glass positioner 144, 144A is rotated toward a segment by 30-180 degrees. Preferably, the glass positioner 144, 144A is rotated by 90 degrees.

In some embodiments (not depicted), the first power component may comprise a servo motor. The servo motor enables movement of a glass positioner 144, 144A vertically in an upward or downward direction. In other embodiments, like the one illustrated in FIG. 6, the first power component 146 may comprise a cam drive 148. The cam drive 148 comprises a drive member 150 which can mechanically communicate with a driven member 152. The drive member 150 may be disposed within a housing 154. A portion of the driven member 152 may also be received by the housing 154.

In an embodiment, the drive member 150 comprises a pneumatic cylinder 156. The pneumatic cylinder 156 may receive pressurized air when it is desired to move a glass positioner 144, 144A vertically in an upward direction. The pneumatic cylinder 156 may discharge the pressurized air when it is desired to move the glass positioner 144, 144A vertically in a downward direction. The first power component 146 may enable vertical movement of a glass positioner 144, 144A from a first position to a second position and from the second position to the first position.

The pneumatic cylinder 156 may comprise a piston 158. The pressurized air received by the pneumatic cylinder 156 may be utilized to urge the piston 158 vertically in an upward direction. Vertical movement of the piston 158 in an upward direction may urge the driven member 152 vertically in an upward direction.

The driven member 152 may be in mechanical communication with the glass positioner 144, 144A on an end and the drive member 150 on the opposite end. The driven member 152 may comprise a cam follower 160. The cam follower 160 is in mechanical communication with a track 162. The track 162 is configured to guide the cam follower 160. Movement of the cam follower 160 in the track 162 enables movement of the driven member 152 in a vertical direction and rotation of the driven member 152. Rotation of the driven member 152 enables rotation of a glass positioner 144, 144A toward a segment 128-134 as described above.

The first power component 146 may be in mechanical communication with a second power component 164. Preferably, the first power component 146 is in mechanical communication with the second power component 164 on a first side thereof. On a second side thereof, the second power component 164 is attached to a frame 166. In an embodiment, the frame 166 is a platform.

The second power component 164 is utilized to move a glass positioner 144, 144A in a direction which is toward or away from the glass sheet 100, 102. In an embodiment, the second power component 164 may comprise a pneumatic cylinder. The pneumatic cylinder may receive pressurized air when it is desired to move a glass positioner 144, 144A toward or away from the glass sheet 100, 102. Similarly, the pneumatic cylinder may discharge the pressurized air when it is desired to move the glass positioner 144, 144A toward or away from the glass sheet 100, 102. The second power component 164 may enable horizontal movement of a glass positioner 144, 144A from a first position to a second position and from the second position to the first position.

The pneumatic cylinder may comprise a piston. The pressurized air received by the pneumatic cylinder may be utilized to urge the piston in a direction which is toward or away from the glass sheet 100, 102. Movement of the piston toward or away from the glass sheet 100, 102 urges the glass positioner 144, 144A toward or away from the glass sheet 100, 102.

In other embodiments (not depicted), the second power component may comprise a servo motor. The servo motor enables movement of a glass positioner 144, 144A toward or away from the glass sheet 100, 102.

The vertical position of each segment 128-134 can be regulated utilizing one or more supports 168. The vertical position of a particular segment 128-134 may be regulated to compensate for changes in the segment or another segment caused by the heating and cooling of the first bending tool 106. The one or more supports 168 each have a length that can be modified. As each segment 128-134 has one or more supports 168 attached thereto, modifying the length of at least one of the one or more supports 168 regulates the position of the segment 128-134. The position of a segment 128-134 is regulated in a vertical direction by increasing or decreasing the length of the one or more supports 150 that are attached to the segment 128-134.

The one or more supports 168 will now be described with reference to the segment illustrated in FIGS. 5 and 7. It should be appreciated that the description provided below for the segment illustrated in FIGS. 5 and 7 is applicable to each segment 128-134 of the first bending tool 106.

Referring now to FIGS. 5 and 7, each support of the one or more supports 168 is attached to the a segment 128-134 and, on an opposite end, each support of the one or more supports 168 is attached to a base member 170. The base member 170 may comprise an upper flange 172. On a side, the upper flange 172 is attached to the one or more supports 168. On an opposite side, the upper flange 172 is attached to a first end of a first wall portion 174 and a first end of a second wall portion 176. The upper flange 172 is also attached to one or more vertically extending ribs 178 at an upper end thereof. A rib 180, 182 of the one or more vertically extending ribs 178 may also be attached to each of the first wall portion 174 and the second wall portion 176. The one or more vertically extending ribs 178 may also be attached to a lower flange 184. A second end of the first wall portion 174 and a second end of a second wall portion 176 may also be attached to the lower flange 184.

In order to enable movement of a segment 128-134, the base member 170 is attached to a pair of hinges 186, 188 via the lower flange 184. The hinges 186, 188 illustrated in FIG. 7 are depicted in an exploded manner with certain portions removed for clarity. It is preferred that each hinge 186, 188 illustrated in FIG. 7 comprises a first member 190, which is attached to the lower flange 184. An opening is provided in the first member 190 for receiving a pin (not depicted). The pin is also disposed through a pair of openings in a second member 192. The first member 190 and the second member 192 are joined by disposing the pin through the openings in each member 190, 192. A bushing (not depicted) may be provided in each of the openings in the second member 192. Preferably, each bushing is disposed around a portion of the pin. In an embodiment, the bushings enable rotation of the pin. In another embodiment, rotation of the pin may be enabled by another type of bearing. The position of the second member 190 is fixed by attaching an end of the second member 190 to the frame 194 or another frame, which is illustrated in FIG. 5.

Each frame 166, 194 is a stationary member. Thus, in embodiments where the first bending tool 106 comprises a frame 166, 194, the segments 128-134 may be movable relative to a frame 166, 194. For example, in an embodiment, the first segment 128 is movable relative to a frame 166, 194. In this embodiment, the first segment 128 may be in a first position relative to the frame 166, 194 and move from the first position to a second position relative to the frame 166, 194. From the second position relative to the frame 166, 194, the first segment 128 can move back to the first position relative to the frame 166, 194 when desired. When the first bending tool 106 comprises other segments 130-134 that are moveable, the other segments 130-134 that are moveable may be in a first position relative to the frame 166, 196 or a second position relative to the frame 166, 196 and those segments 130-134 may move from the first position relative to the frame 166, 196 to the second position relative or vice versa as described above for the first segment 128. Also, the glass sheet 100, 102 is movable relative to a frame 166, 196. For example, after a glass sheet 100, 102 is deposited on the first bending tool 106 and prior to the glass sheet 100, 102 being shaped, the glass sheet 100, 102 may be in a first position relative to a frame 166, 196 and move from the first position relative to the frame 166, 196 to a second position relative to the frame 166, 196. Additionally, at least one of the one or more glass positioners 144, 144A is movable relative to a frame 166, 196. Preferably, each frame 166, 196 is constructed of a rigid material.

Each segment 128-134 and each positioning apparatus 136-142 may be regulated by one or more controllers (not depicted). The one or more controllers regulate each segment 128-134 and each positioning apparatus 136-142 by providing signals which direct power or pressurized gas to portions 146, 164 of the first bending tool 106.

For example, power or pressurized air may be directed to the first power component 146, the second power component 164, and/or another portion of the first bending tool 106 before adjusting the position of a glass sheet 100, 102. In an embodiment, pressurized air or power is directed to the second power component 164 when it is desired to move a glass positioner 144, 144A from a first position to a second position or a third position to a fourth position. In other embodiments, pressurized air or power is directed to the first power component 146 and the second power component 164 after adjusting the position of a glass sheet 100, 102. In one such embodiment, power is directed to the second power component 164 when it is desired to move a glass positioner 144, 144A from a second position to a first position or a fourth position to a third position. In another embodiment, power is directed to the second power component 164 when it is desired to move a glass positioner 144, 144A from a second position to a third position or a fourth position to a first position.

However, as indicated above, the one or more controllers may be in communication with and provide signals to other portions of the first bending tool 106 such as, for example, a drive mechanism (not depicted). Additionally, the one or more controllers may be in communication with and provide signals to the plurality of rollers 118 and the fluid pad assembly 120. The signals provided by the one or more controllers to the first bending tool 106 and the drive mechanism may direct movement of the first bending tool 106, plurality or rollers 118, and/or fluid pad assembly 120 vertically in a downward direction or in an upward direction. It should also be appreciated that, in certain embodiments, the one or more controllers are in communication with and provide a signal to the second bending tool 124 to direct movement of the second bending tool 124 vertically in a downward direction or in an upward direction. The one or more controllers may also be in communication with and provide signals to the one or more glass stopping apparatuses 114, 114A to regulate positioning of a glass sheet 100, 102 prior to the glass sheet 100, 102 being deposited on the first bending tool 106.

In certain embodiments, the one or more controllers may operate and/or provide the signals described above under the control of a set of programming instructions, which may also be referred to as software. The one or more controllers may include a memory (not depicted) in which programming instructions are stored. In an embodiment, the set of programming instructions enables the one or more controllers to regulate a flow of fluid, positioning of a glass sheet 100, 102 relative to the shaping surface 116, and/or movement of the bending tools 106, 124, plurality of rollers 118, and fluid pad assembly 120 in a predetermined sequence.

The one or more controllers may also receive signals. For example, the one or more controllers may be in communication with an optical sensor (not depicted) which indicates the location of a glass sheet 100, 102 in the glass shaping line 104. In other embodiments, the one or more controllers may receive a signal from the first bending tool 106, one or more glass stopping apparatuses 114, 114A, second bending tool 124, one or more valves, and/or a drive mechanism connected to the plurality of rollers 118 and fluid pad assembly 120.

After a glass sheet 100, 102 has been deposited on the first bending tool 106 and prior to being shaped, the position of the glass sheet 100, 102 may be adjusted relative to the shaping surface 116 of the first bending tool 106. To adjust the position of a glass sheet 100, 102 relative to the shaping surface 116 of the first bending tool 106, at least one of the glass positioners 144, 144A moves as described above to contact an edge portion of the glass sheet 100, 102. In an embodiment, the first glass positioner 144 of the first positioning apparatus 136 moves from a first position to a second position or from a third position to a fourth position to contact the first edge portion of the glass sheet 100, 102. In this embodiment, the first edge portion of the glass sheet 100, 102 is the trailing edge portion of the glass sheet 100, 102. However, in other embodiments, the first edge portion of the glass sheet 100, 102 may be a pillar edge portion of the glass sheet 100, 102. Preferably, a second edge portion of the glass sheet 100, 102 is contacted by one or more glass positioners 144, 144A to adjust the position the glass sheet 100, 102 relative to the shaping surface 116 of the first bending tool 106. In an embodiment, two glass positioners 144, 144A each move from a first position to a second position or a third position to a fourth position to contact the second edge portion of the glass sheet 100, 102. In this embodiment, the second edge portion of the glass sheet 100, 102 may be a pillar edge portion of the glass sheet 100, 102. However, in other embodiments, the second edge portion of the glass sheet 100, 102 may be the leading edge portion of the glass sheet 100, 102. In still other embodiments, a third edge portion of the glass sheet 100, 102 is contacted by one or more glass positioners 144, 144A to adjust the position of the glass sheet 100, 102 relative to the shaping surface 116 of the first bending tool 106. In some embodiments, the one or more glass positioners 144, 144A move from a first position to a second position or from a third position to a fourth position to contact the third edge portion of the glass sheet 100, 102. In one such embodiment, the third edge portion of the glass sheet 100, 102 is a first pillar edge portion or a second pillar edge portion of the glass sheet 100, 102. Preferably, the third edge portion of the glass sheet 100, 102 is trailing edge portion of the glass sheet 100, 102. Also, it may be preferred that a fourth edge portion of the glass sheet 100, 102 is contacted by one or glass positioners 144, 144A to adjust the position of the glass sheet 100, 102 relative to the shaping surface 116 of the first bending tool 106. In some embodiments, the one or more glass positioners 144, 144A moves from a first position to a second position or a third position to a fourth position to contact the fourth edge portion of the glass sheet 100, 102. In one such embodiment, the fourth edge portion of the glass sheet 100, 102 is the leading edge portion of the glass sheet 100, 102. However, another embodiment, the fourth edge portion of the glass sheet 100, 102 is the first pillar edge portion or the second pillar edge portion of the glass sheet 100, 102.

Referring back to FIG. 1, in embodiments where the glass sheets 100, 102 are shaped via press bending, movement between the first bending tool 106 and the second bending tool 124 occurs to shape each glass sheet 100, 102. In embodiments where a glass sheet 100, 102 is to be press bent, once a glass sheet 100, 102 has been positioned relative to the shaping surface 116 of the first bending tool 106 as described above, it is preferred that the first bending tool 106 moves toward the second bending tool 124, with the second bending tool 124 not moving, to press bend the glass sheet 100, 102. In this embodiment, following movement of the first bending tool 106, the glass sheet 100, 102 is press bent between the first bending tool 106 and the second bending tool 124. However, in other embodiments, the first bending tool 106 may move toward the second bending tool 124 and the second bending tool 124 may move toward the first bending tool 106. Alternatively, the second bending tool 106 may move toward the first bending tool 106, with the first bending tool 106 not moving. In any of these alternatives the objective is to effect relative movement between the first bending tool 106 and the second bending tool 124 to press bend the glass sheet 100, 102 between the first bending tool 106 and the second bending tool 124.

During pressing, a vacuum may be drawn on passages 196 formed in the second bending tool 124 to facilitate forming the glass sheet 100, 102 into a desired shape. Upon completion of shaping the glass sheet 100,102, the glass sheet 100, 102 may be released from the second bending tool 124 by way of positive pressure being applied through the passages 196 of the second bending tool 124.

Upon completion of the bending process, a conveying device (not shown) serves to transport the shaped glass sheet 100, 102 into a lehr 198. In the lehr 198, the shaped glass sheet 100, 102 may be tempered or annealed as known in the art and cooled to a temperature at which handling can occur. The shaped glass sheet 100, 102 may be used in the construction of a window for a vehicle, such as a windscreen, side window, sunroof or a rear window. Such a window may be monolithic or laminated.

In accordance with the provisions of the patent statutes, the present invention has been described in what is considered to represent its preferred embodiments, however, it should be noted that the invention can be practiced otherwise than as specifically illustrated and described without departing from its scope or spirit.

1-11. (canceled)

12. A method of shaping glass sheets, comprising:
providing a first glass sheet;
heating the first glass sheet to a temperature suitable for shaping;
depositing the first glass sheet on a first bending tool, a first edge portion of the first glass sheet being in a first position relative to the first bending tool;
contacting the first edge portion of the first glass sheet after the first glass sheet has been deposited on the first bending tool such that the first edge portion of the first glass sheet is moved to a second position relative to the first bending tool;
shaping the first glass sheet on the first bending tool;
providing a second glass sheet;
heating the second glass sheet to a temperature suitable for shaping;
depositing the second glass sheet on the first bending tool, a first edge portion of the second glass sheet being in a first position relative to the first bending tool;
contacting the first edge portion of the second glass sheet after the second glass sheet has been deposited on the first bending tool such that the first edge portion of the second glass sheet is moved to a second position relative to the first bending tool, wherein the second position of the first edge portion of the first glass sheet relative to the first bending tool is different than the second position of the first edge portion of the second glass sheet relative to the first bending tool; and
shaping the second glass sheet on the first bending tool.

13. The method of claim 12, wherein the first glass sheet and the second glass sheet are of different sizes.

14. The method of claim 12, wherein one or more edge portions of the first glass sheet have a length which is different than a length of a corresponding edge portion of the second glass sheet.

15. The method of claim 12, wherein the first glass sheet and the second glass sheet each comprise a leading edge portion and a trailing edge portion, and wherein the first edge portion of the first glass sheet defines the trailing edge of the first glass sheet, and the first edge portion of the second glass sheet defines the trailing edge of the second glass sheet.

16. The method of claim 15, wherein the trailing edge of the first glass sheet and the trailing edge of the second glass sheet each have a length, the length of the trailing edge of the first glass sheet being different from the length of the trailing edge of the second glass sheet.

17. The method of claim 12, wherein the first glass sheet and the second glass sheet each comprise a leading edge portion and a trailing edge portion, with a first pillar edge portion and a second pillar edge portion extending therebetween, each of the first pillar edge portions having a length, and wherein the length of the first pillar edge portion of the first glass sheet is different from the length of the first pillar edge portion of the second glass sheet.

18. The method of claim 12, wherein the first bending tool comprises a female, ring-type mold.

19. The method of claim 12, wherein the first bending tool cooperates with a second bending tool to shape the first glass sheet and the second glass sheet.

20. The method of claim 19, wherein the second bending tool comprises a full-face male mold.

21. The method of claim 12, wherein the first glass sheet and the second glass sheet are shaped consecutively, such that no glass sheet is shaped on the first bending tool between the shaping of the first glass sheet and the shaping of the second glass sheet.

22. The method of claim 12, further comprising laminating the first glass sheet to the second glass sheet.
